(19) United States
(12) Patent Application Publication
(10) Pub. No.: US 2025/0269448 A1
(43) Pub. Date: Aug. 28, 2025

(54) ADAPTIVE CENTERING

(71) Applicant: Klingelnberg AG, Zürich (CH)

(72) Inventors: Florian Kienzle, Möglingen (DE); Ruben Burkart, Rheinstetten (DE)

(21) Appl. No.: 19/061,456

(22) Filed: Feb. 24, 2025

(30) Foreign Application Priority Data
Feb. 26, 2024 (EP) 24159795.4

(51) Int. Cl. B23F 1/02

(52) U.S. Cl. CPC B23F 1/02

(57) ABSTRACT

Method, comprising the method steps of: generating grinding of toothings (16), wherein a respective toothing (16) is machined by means of a plurality of grinding strokes and wherein a centering position for positioning a grinding tool (10) relative to the respective toothing (16) is predetermined for the grinding strokes, and adapting the centering position on the basis of a performance parameter (M2) of a workpiece spindle (6) accommodating the respective toothing (16).

### CROSS-REFERENCE TO RELATED APPLICATIONS

This application claims the benefit of European patent application no. 24159795.4, filed on 26 Feb. 2024, the disclosure of which is incorporated herein by reference in its entirety.

### TECHNICAL FIELD

The present disclosure relates to a method comprising the following method steps: generating grinding of toothings, wherein a respective toothing is machined by means of a plurality of grinding strokes, wherein a centering position for positioning a grinding tool relative to the respective toothing is predetermined for the grinding strokes.

### BACKGROUND

In generating grinding, a gap center of a toothing of a workpiece to be ground is determined, for example, by grinding the toothing using the grinding worm. This process is referred to as centering, as finding the center of the gap serves to correctly position the grinding tool relative to the toothing to be ground. Alternatively, the gap center can be found using sensors, which are also referred to as centering sensors.

In series production, the quality of the centering, i.e. the accuracy of the centering, depends on a number of influencing factors, such as the accuracy of centering sensors, component quality and the like. For example, the distribution of a pitch error of the respective toothings, a changing stock allowance or similar deviations, which differ from workpiece to workpiece, can have a major influence on the quality of the centering.

The deviations during centering can result in toothing errors, such as waviness, form errors or toothings ground on one side.

The ever-increasing demands on the quality of the respective ground toothings, i.e. in particular the very tight tolerances required, demand an equally increasing quality for the centering process, which forms the basis for the subsequent generating grinding.

Against this background, the present disclosure is based on the technical problem of providing an improved method of the type mentioned at the beginning, which in particular enables improved centering and further in particular monitoring of the quality of the centering for generating grinding.

### SUMMARY

The technical problem described above is solved with the features of the independent claim. Further designs of the disclosure result from the dependent claims and the following description.

According to the disclosure, a method is provided comprising the following method steps: generating grinding of toothing, wherein a respective toothing is machined by means of several grinding strokes and wherein a centering position for positioning a grinding tool relative to the respective toothing is predetermined for the grinding strokes. The method is characterized by adapting the centering position on the basis of a performance parameter of a workpiece spindle accommodating the respective toothing.

Investigations by the applicant have shown that performance parameters of the workpiece spindle, such as the torque or the current consumption of a drive of the workpiece spindle, correlate with the accuracy of the centering. If a grinding tool is poorly centered in relation to the teeth, i.e. the position of the tooth spaces to be ground relative to the grinding worm has not been correctly determined, this results in torques that are too high or too low in the area of the workpiece spindle during grinding, for example, as too much or too little material is removed. The quality of the centering can therefore be measured on the workpiece spindle.

The performance parameter of the workpiece spindle can therefore be used to correct or control the centering position.

Based on the performance parameter of the workpiece spindle, improved centering and monitoring of the quality of the centering for generating grinding can be achieved.

The term “centering” describes the positioning of the grinding tool, in this case a worm for generating grinding, relative to the teeth to be machined on the toothing of a workpiece or component to be ground. After clamping the toothing on the workpiece spindle, the position of the teeth within the machine tool or their relative rotational position is initially unknown. The position of the gear or gears of the grinding worm and the rotational position of the grinding worm are usually known from the dressing or from a previous grinding process. Accordingly, the position of the teeth of the workpiece must be recorded and the workpiece must be aligned relative to the grinding worm or vice versa so that the grinding worm can be brought into reliable and precise engagement with the teeth.

The term “centering position” therefore describes, in particular, axis positions of a machine tool that are specified on the basis of a measured position of the teeth of a toothing to be ground for positioning the grinding tool relative to the teeth of the toothing. The terms “centering” and “centering position” are well known in the prior art and are familiar to a person skilled in gear technology.

If reference is made to generating grinding of toothings in the present case, this concerns in particular the successive generating grinding of toothed components or workpieces, each of which has such a toothing.

The performance parameter can be recorded during grinding. In particular, the performance parameter can be recorded for each grinding stroke or during each grinding stroke.

The performance parameter can be a torque of a motor of the workpiece spindle. The torque can be measured directly or indirectly.

The performance parameter can be a current consumption of the motor of the workpiece spindle.

In the present case, generating grinding is in particular continuous generating grinding, wherein the grinding tool is a grinding worm.

The grinding worm is in particular a dressable grinding worm. The grinding worm can be single-start or multi-start.

Generating grinding can be finishing, roughing or polishing.

Adjusting the centering position may involve determining a correction value for adjusting the centering position. For example, such a correction value can be added to an existing value of the centering position, subtracted from it or be a factor. It is understood that a plurality of correction values can be specified for the respective machine axes of a multi-axis machine for gear grinding.

The toothing and the grinding tool or grinding worm perform a coupled movement during continuous generating grinding.

Accordingly, a correction of the centering position can be made, for example, by correcting a relative rotational position or angular position of the toothing with respect to the rotational axis of the toothing relative to the grinding worm by assigning a correction value around the rotational axis of the toothing to a predetermined rotational position of the toothing.

Alternatively or additionally, the centering position can be corrected, for example, by correcting a relative rotational position or angular position of the grinding tool with respect to the rotational axis of the tool relative to the toothing by assigning a correction value around the rotational axis of the grinding tool to a predetermined rotational position of the grinding tool.

Alternatively or additionally, a predetermined position of the grinding worm along a tool shift direction parallel to the tool rotation axis, i.e. the shift position of the grinding worm to the toothing, can be used to correct the centering position by assigning a correction value to a predetermined position of the grinding worm in the tool shift direction.

The centering position can therefore be set in particular by correcting the tool rotation position and/or the workpiece rotation position and/or the tool shift position.

Depending on the type of machine, the rotation axis of the toothing can be arranged coaxially to a physical CNC-controlled workpiece rotation axis of the workpiece spindle. Specifying a correction value for the rotational position of the workpiece therefore corresponds to a correction of a rotational position or angular position of the toothing by means of the workpiece spindle.

Depending on the type of machine, the rotation axis of the grinding tool can be arranged coaxially to a physical CNC-controlled tool rotation axis of the tool spindle. Specifying a correction value for the rotational position of the tool therefore corresponds to a correction of a rotational position or angular position of the grinding tool by means of the tool spindle.

Depending on the type of machine, the shift direction of the grinding tool can be arranged coaxially to a physical CNC-controlled shift axis, which is a linear axis. Specifying a correction value for the shift position of the tool along the shift direction therefore corresponds to a correction of a position of the toothing by means of the shift axis.

Depending on the type of machine, the correction of the centering position can be made by superimposing corrections of several machine axes.

The centering position can therefore be achieved in particular by means of a correction of the tool rotation axis and/or the workpiece rotation axis and/or the tool shift axis. Depending on the type of machine, the correction of the centering position can be carried out by superimposing corrections of several machine axes.

Furthermore, the centering position can be corrected, for example, by correcting a relative position of the toothing with respect to the grinding worm by means of the workpiece rotation axis by assigning a correction value to a specified position of the toothing on the workpiece rotation axis.

Alternatively or additionally, a predetermined position of the grinding worm can be corrected by means of a tool rotation axis, i.e. the rotational position of the grinding worm relative to the toothing, by assigning a correction value to a predetermined position of the grinding worm on the tool rotation axis.

Alternatively or additionally, a predetermined position of the grinding worm can be used to correct the centering position by means of a tool shift axis, i.e. the shift position of the grinding worm relative to the toothing, in which a correction value is assigned to a predetermined position of the grinding worm on the tool shift axis.

The centering position can therefore be achieved in particular by means of a correction of the tool rotation axis and/or the workpiece rotation axis and/or the tool shift axis. Depending on the type of machine, the correction of the centering position can be carried out by superimposing corrections of several machine axes.

A correction of the centering position can be up to 100 μm on the pitch circle of the respective toothing in a direction normal to the tooth flank, in particular up to 30 μm. In other words, faulty centering without using the method according to the disclosure can lead to up to 100 μm too much or too little being removed during generating grinding in a direction normal to the tooth flank.

The adjustment of the centering position can include a comparison of the performance parameter with at least one reference parameter.

The reference parameter may have been determined before generating grinding.

The reference parameter may have been determined based on the machining of a reference workpiece. The reference workpiece can, for example, be a very precisely manufactured workpiece that represents an optimum workpiece with regard to the allowance and measured gear deviations of the toothing to be ground. Furthermore, the reference can be determined by very precise centering in order to enable an optimum grinding process or a reference process. Centering can be performed for the reference process, in particular by tactile contact with the tooth flanks of the reference workpiece. The reference parameter can correspond to a reference torque that is measured on the workpiece spindle during grinding of the reference workpiece.

The reference parameter can correspond to an idle torque of the workpiece spindle. Investigations by the applicant have surprisingly shown that the torque measured on the workpiece spindle during generating grinding for a well-centered toothing essentially corresponds to an idle torque of the workpiece spindle.

The idle torque can be measured while the workpiece spindle is rotating at the intended speed of generating grinding with the toothing held on it, without the grinding tool being in cutting contact with the toothing. The algebraic sign of the idle torque measured on the workpiece spindle results from the intended direction of rotation of the workpiece spindle.

It may be provided that a tolerance range is specified for the performance parameter of the workpiece spindle, wherein no adjustment of the centering position is made if the performance parameter is within the tolerance range, and wherein an adjustment of the centering position is made if the performance parameter is outside the tolerance range.

The tolerance range may have been determined on the basis of the reference parameter. This means that the tolerance range can be determined, for example, using the measured reference torque from the reference process and/or using the measured idle torque. For example, a percentage deviation from the respective reference parameter can be specified, which defines the tolerance range.

For the example of the idle torque as a reference value, the measured idle torque for a component rotation without sliding contact can be e.g. 5 Newton meters (Nm). As a tolerance range, a deviation of +/−50% of the idle torque can be defined as permissible. This results in a lower threshold of the tolerance range of 2.5 Nm and an upper threshold of 7.5 Nm. For this numerical example, the centering position is not adjusted if the torque of the workpiece spindle measured during generating grinding is greater than or equal to 2.5 Nm and less than or equal to 7.5 Nm, and therefore within the tolerance range. For this numerical example, the centering position is adjusted if the torque of the workpiece spindle measured during generating grinding is less than 2.5 Nm or greater than 7.5 Nm and is therefore outside the tolerance range.

It is understood that the aforementioned values are merely examples and are to be adapted individually for each toothing process.

For example, a module-dependent correction value can be taken into account for the tolerance range in order to account for different component and toothing dimensions.

For example, it may be provided that a machine-specific correction value can be taken into account for the tolerance range in order to take account of different spindle and machine types.

According to one design of the method, it may be provided that a threshold value is specified for the performance parameter, wherein no adjustment of the centering position is made if the performance parameter exceeds the threshold value, and wherein an adjustment of the centering position is made if the performance parameter exceeds the threshold value. Instead of a tolerance range, for example, only a threshold value can be defined for the performance parameter, on the basis of which a correction requirement for the centering position is determined.

The threshold value may have been determined on the basis of the reference parameter. This means that the threshold value can be determined, for example, using the measured reference torque from the reference process and/or using the measured idle torque. For example, a percentage deviation from the respective reference parameter can be specified, which determines the threshold value.

For the example of the reference torque as a reference value, the measured reference torque in the sliding contact can be 5 Nm, for example. A value of 10 Nm, for example, can be defined as a permissible threshold value. For this numerical example, the centering position is not adjusted if the torque of the workpiece spindle measured during generating grinding is less than or equal to 10 Nm and thus falls below the threshold value or the threshold torque. For this numerical example, the centering position is adjusted if the torque of the workpiece spindle measured during generating grinding is greater than 10 Nm and therefore exceeds the threshold value or threshold torque.

The relationship between the measured performance parameter and the required correction of the centering position can be determined empirically with the help of tests. For example, a measured deviation of a torque during generating grinding from an idle torque can be converted directly into a correction of a rotational position of the workpiece spindle. For example, such tests can show that, depending on the gear geometry, a correction of 0.1 μrad (microradian), or 0.5 μrad or 1 μrad must be made to the rotational position of the toothing on the workpiece spindle for every 1 Nm deviation of the torque during generating grinding from a idle torque, provided, for example, an approximate linear relationship results. Such data can, for example, be stored in formulas or tables in a machine control system. The aforementioned values are again to be understood as examples for illustration purposes.

The adjustment of the centering position can take place between the grinding strokes for machining a respective toothing, wherein in particular after a first grinding stroke an adjustment of the centering position takes place before a second grinding stroke for the second grinding stroke and for subsequent grinding strokes.

Alternatively or additionally, it may be provided to adjust the centering position during a grinding stroke. In this way, the production of rejects can be avoided.

Alternatively or additionally, it may be provided that the adjustment of the centering position takes place after the grinding of a respective toothing and before the grinding of a further toothing.

After the adjustment of the centering position, the grinding of the same toothing can be repeated, wherein in particular at least one grinding stroke that has already been performed is carried out again.

After adjusting the centering position, the toothing can be discarded as scrap and the next toothing can be ground with the adjusted centering position.

The deviations during centering can be caused by various influences. For example, a temperature-related drift due to the heating of a machine after a cold start can lead to the fact that a centering position should be adjusted step by step in order to achieve optimum machining results. In this case, it may be provided to transfer a corrected centering position from component to component or from toothing to toothing in order to gradually adjust the centering position to the temperature drift.

In the event of deviations during centering due to systematic influences, it is possible to define an adjusted centering position of a first toothing of a first component as a predefined centering position for a second toothing of a second component to be machined subsequently.

If the deviations during centering are chaotic, i.e. not systematic, transferring the corrections in this way makes less sense. In this case, each toothing should be checked and corrected individually so that the same centering position is always used as the specified centering position from toothing to toothing or from component to component.

Before grinding, a centering of the grinding tool can be carried out for a respective toothing by means of a sensor.

Before grinding, a centering of the grinding tool can be carried out for a respective toothing by whetting.

### BRIEF DESCRIPTION OF THE DRAWINGS

The disclosure is described in more detail below with reference to a drawing illustrating exemplary embodiments. The drawings schematically show in each case:

FIG. 1 shows a gear grinding machine;

FIG. 2 shows a grinding worm with a toothed workpiece;

FIG. 3 shows measured values for a single-centering position to be corrected;

FIG. 4 shows measured values for a corrected centering position;

FIG. 5 shows measured values for a centering position to be corrected;

FIG. 6 shows measured values for a corrected centering position;

FIG. 7 shows a flow chart of a method according to the disclosure;

FIG. 8 shows measured values for a centering position to be corrected; and

Fig. shows measured values for a centering position to be corrected.

### DETAILED DESCRIPTION OF THE DRAWINGS

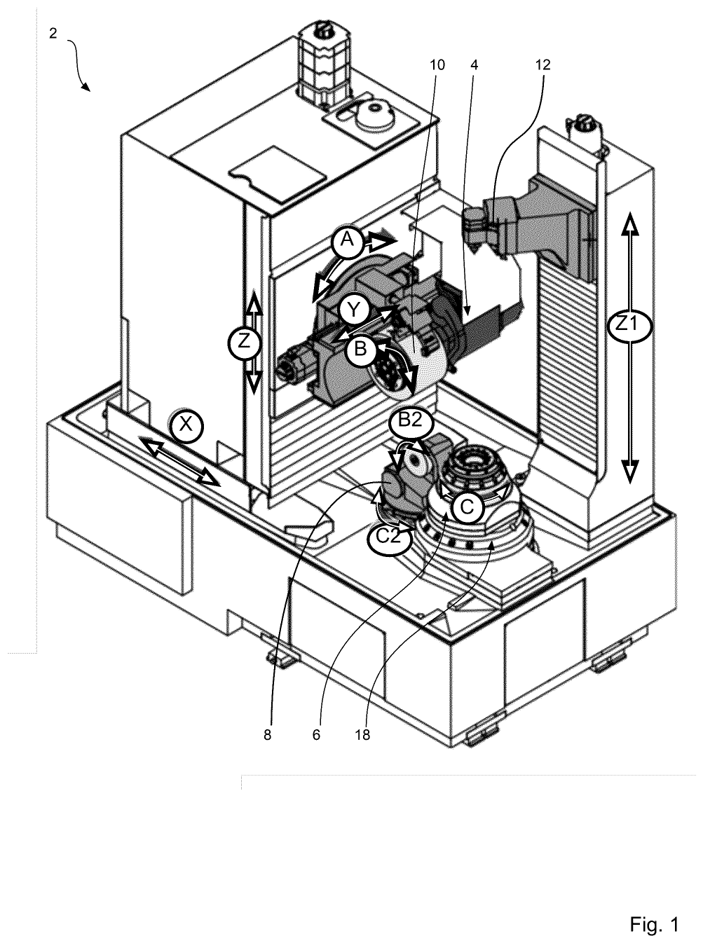

FIG. 1 shows a gear grinding machine 2. The gear grinding machine 2 has a tool spindle 4 for holding and rotationally driving a grinding tool 10. The gear grinding machine 2 has a workpiece spindle 6 for holding and rotationally driving a toothed component to be ground. The gear grinding machine 2 has a dressing device 8 for dressing grinding tools.

The gear grinding machine 2 has numerically controlled machine axes X, Y, Z, A, B, C, C2, B2 for executing translational and rotational relative movements in order to provide the required machining kinematics during gear cutting or dressing. Furthermore, the gear grinding machine 2 has an axis Z1 with a movable quill 12 for clamping shafts or mandrels.

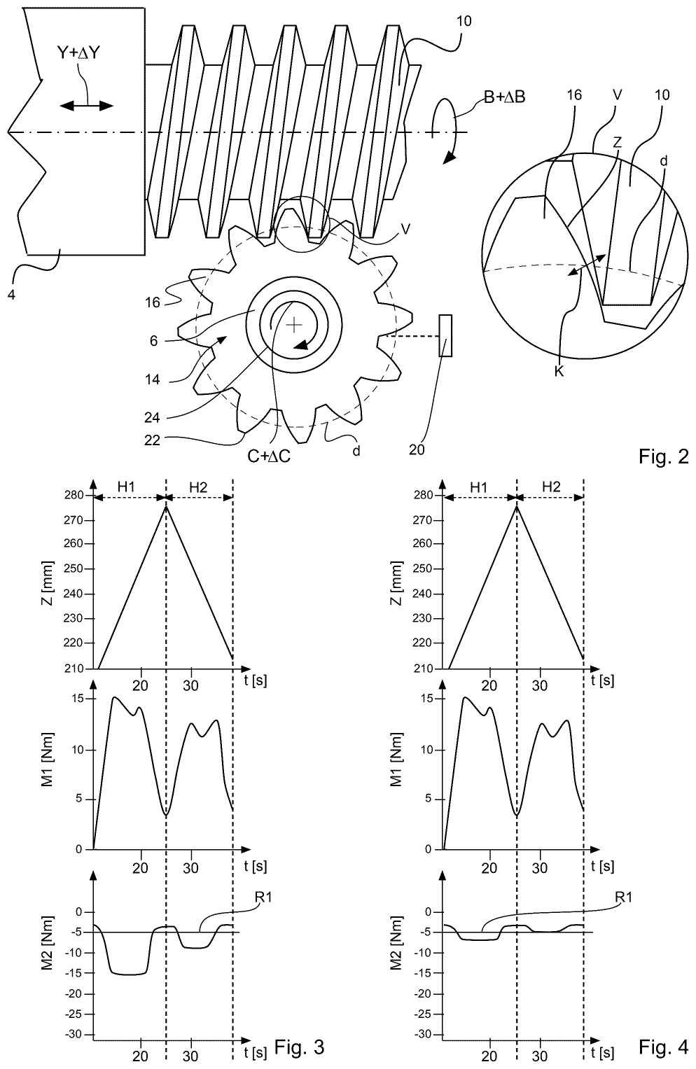

A workpiece 14, which has a toothing 16 to be ground, is held on the workpiece spindle 6 (FIG. 2). The workpiece spindle 6 has a drive 18 or motor 18 for rotating the workpiece 14 around its longitudinal axis (FIG. 1).

The gear grinding machine 2 has a non-contact, inductive centering sensor 20 for detecting the position of tooth heads 22 of the toothing 16 (FIG. 2). The illustration of the centering sensor 20 is schematic, as are the other figures.

A torque sensor 24 is assigned to the workpiece spindle 6 to detect the torque of the workpiece spindle 6. The torque can also be detected without a torque sensor within a control system, wherein the torque is calculated using operating data from the drive 18.

According to the disclosure, a method is carried out comprising the method steps of:
(A) Generating grinding of toothings, wherein a respective toothing 16 is machined by means of a plurality of grinding strokes and wherein a centering position for positioning a grinding tool 10 relative to the respective toothing 16 is predetermined for the grinding strokes; and
(B) Adjusting the centering position based on a performance parameter of the workpiece spindle 6 holding the respective toothing 16.

The grinding tool 10 is a dressable grinding worm.

The performance parameter is measured during grinding.

The method according to the disclosure is described in more detail below using the diagrams in FIGS. 3 and 4.

FIG. 3 shows a stroke Z [mm], a torque M1 [Nm] of the tool spindle 4 and a torque M2 [Nm] of the workpiece spindle 6, each plotted over a time axis t [s].

The area H1 describes a first grinding stroke and the area H2 describes a second grinding stroke H2, which the grinding worm 10 performs for generating grinding of the toothing 16. The grinding stroke H1 is performed in synchronization. The grinding stroke H2 is performed in the opposite direction. In grinding stroke H1, an allowance of approx. 60 μm is removed. In grinding stroke H2, an allowance of approx. 35 μm is removed.

In this case, the measured performance parameter for adjusting the centering position is the torque M2 of the motor 18 of the workpiece spindle 6.

The torque M2 of the workpiece spindle 6 measured during generating grinding deviates significantly from an idle torque of the workpiece spindle 6. The idle torque of the workpiece spindle 6 forms a reference parameter R1 for the measured torque M2 of the workpiece spindle 6.

The idle torque is −5 Nm. The negative sign results from the direction of rotation of the workpiece spindle 6.

Due to the large deviation of the measured torque M2 of the workpiece spindle 6 from the idle torque R1, the centering position is adjusted. This is because for the first stroke H1 and for the second stroke H2, far too much material is assumed from the left flanks of the toothing 16, which can be deduced from the increased torque.

The centering position is adjusted by changing a relative position of the grinding tool 10 to the toothing 16 to be ground by assigning one or more correction values ΔB, ΔC, ΔY to the axis positions. In the simplest case, for example, only the rotational position C of the workpiece 14 is corrected by moving to the position C+ΔC. This correction can also be carried out for the shift direction according to the shift axis Y and/or the rotational position of the tool according to the tool rotation axis B.

In this example, the shift direction is oriented parallel to the linear degree of freedom of the shift axis Y or the shift direction runs parallel to the linear travel of the shift axis. Furthermore, the rotational axis of the workpiece is oriented coaxially to the rotational axis C of the workpiece spindle and the rotational axis of the tool is oriented coaxially to the rotational axis B of the tool spindle.

For a subsequent, further component 14 to be ground, the centering position corrected in this way is therefore set, for which the toothing 16 of the further component has now been rotated clockwise by a few microns according to the correction value ΔC, for example, in order to improve the centering position. In this way, a correction K of the centering position on the pitch circle d of the respective toothing 16 can be achieved in a direction normal to the respective tooth flank Z, which is up to 30 μm or up to 100 μm. This is shown in an enlarged representation V of the engagement of tool 10 and workpiece 14 according to FIG. 2.

The result of this correction is shown in FIG. 4. The torque M2 measured during grinding of the toothing 16 of the subsequent component 14 is now significantly closer to the idle torque of −5 Nm for both grinding strokes H1, H2, so that good centering can be assumed.

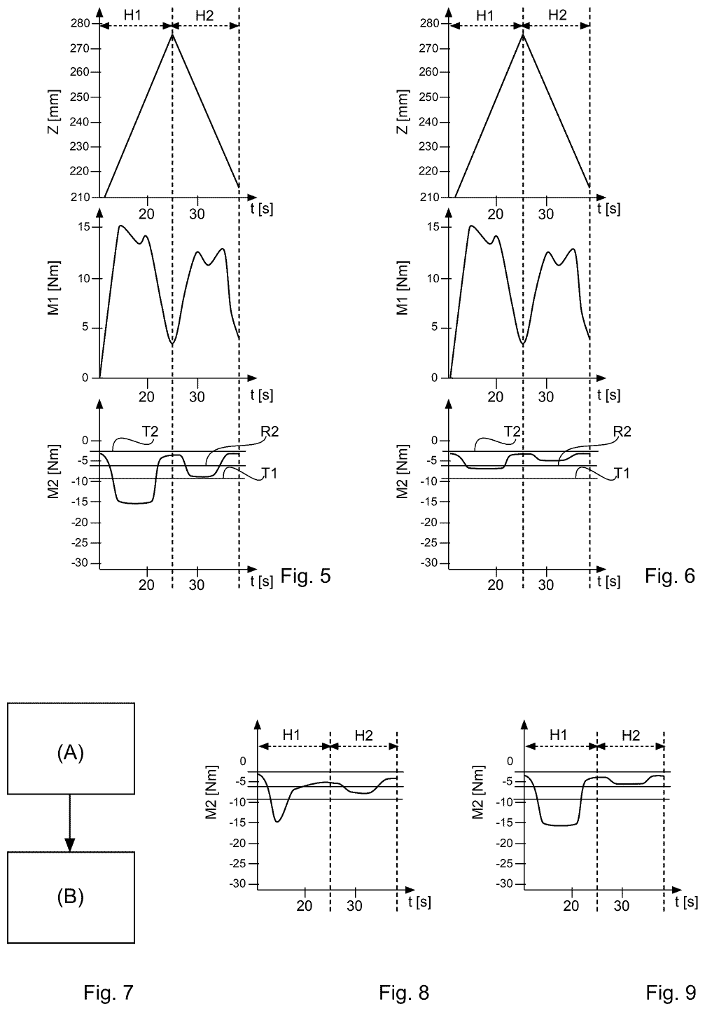

The diagrams show schematically averaged and smoothed values for the torques M1 and M2. In reality, the torque M2 curve for FIG. 3 and FIG. 4 is not exactly identical, but only approximately the same with regard to the averaged curve. In particular, after the correction, a fluctuation of the torque M2 is reduced by the mean curve shown. This applies equally to FIGS. 5 and 6.

Instead of the idle torque R1, a reference parameter R2 can be determined based on the machining of a reference workpiece.

The reference workpiece corresponds to one of the components 14 to be machined, wherein this component used as a reference workpiece has particularly small deviations from the specified tolerances and is centered particularly precisely. During the grinding machining of the toothing 16 of this reference workpiece, a reference torque R2 is determined, which is e.g. −6 Nm (FIG. 5).

With regard to the reference torque R2, a tolerance range T1-T2 is defined, with a first threshold T1 and a second threshold T2.

According to FIG. 5, an adjustment of the centering position is required, as the performance parameter M2 is outside the tolerance range T1-T2. According to FIG. 6, the centering position has been corrected for the subsequent toothing 16 or the subsequent component 14 to be ground, wherein the performance parameter M2 is now within the tolerance range T1-T2.

Instead of using the tolerance range T1-T2, only the threshold T1 can be taken into account as the threshold value, so that T2 can be omitted.

FIG. 8 shows a design of the method, wherein a correction of the centering position already takes place during the first grinding stroke H1.

FIG. 9 shows a design of the method in which the centering position is corrected after the first grinding stroke H1, so that the second grinding stroke H2 is carried out with a corrected centering position.

1. Method, having the method steps of:
generating grinding of toothings (16), wherein a respective toothing (16) is machined by means of a plurality of grinding strokes and wherein a centering position for positioning a grinding tool (10) relative to the respective toothing (16) is predetermined for the grinding strokes,
characterized by
adapting the centering position on the basis of a performance parameter (M2) of a workpiece spindle (6) accommodating the respective toothing (16).

2. Method according to claim 1, characterized in that the performance parameter (M2) is measured during grinding.

3. Method according to one of the preceding claims,
characterized in that
the performance parameter (M2) is a torque (M2) of a motor (18) of the workpiece spindle (6)
or
the performance parameter is a current consumption of the motor (18) of the workpiece spindle (6).

4. Method according to one of the preceding claims,
characterized in that
the adjustment of the centering position comprises a determination of a correction value (ΔB, ΔC, ΔY) for adjusting the centering position and/or
a correction of the centering position on the pitch circle of the respective toothing (16) in a direction normal to the tooth flank is up to 100 μm, in particular up to 30 μm.

5. Method according to one of the preceding claims,
characterized in that
the adjustment of the centering position comprises a comparison of the performance parameter (M2) with at least one reference parameter (R1, R1).

6. Method according to claim 5,
characterized in that
the reference parameter (R1, R2) has been determined before generating grinding.

7. Method according to claim 5 or claim 6,
characterized in that
the reference parameter (R2) has been determined on the basis of the machining of a reference workpiece (14).

8. Method according to claim 5 or claim 6,
the reference parameter (R1) corresponds to an idle torque of the workpiece spindle (6).

9. Method according to one of the preceding claims,
characterized in that
a tolerance range (T1-T2) is specified for the performance parameter (M2),
wherein no adjustment of the centering position is made if the performance parameter (M2) is within the tolerance range, and wherein an adjustment of the centering position is made if the performance parameter is outside the tolerance range.

10. Method according to claim 9 and according to one of claims 5-9,
characterized in that
the tolerance range (T1-T2) has been determined on the basis of the reference parameter (R1, R2).

11. Method according to one of claims 5-9,
characterized in that
a threshold value (T1, T2) is specified for the performance parameter (M2), wherein no adjustment of the centering position is made if the performance parameter (M2) exceeds the threshold value (T1, T2), and wherein an adjustment of the centering position is made if the performance parameter (M2) exceeds the threshold value (T1, T2), wherein the threshold value (T1, T2) has been determined on the basis of the reference parameter (R1, R2).

12. Method according to one of the preceding claims,
characterized in that
the adjustment of the centering position takes place between the grinding strokes for machining a respective toothing, wherein in particular after a first grinding stroke an adjustment of the centering position takes place before a second grinding stroke for the second grinding stroke and for subsequent grinding strokes
and/or
the adjustment of the centering position takes place during a grinding stroke
and/or
the adjustment of the centering position takes place after the grinding of a respective toothing and before the grinding of a further toothing.

13. Method according to one of the preceding claims,
characterized in that
the grinding of the respective toothing is repeated after the adjustment of the centering position, wherein in particular at least one grinding stroke that has already been performed is carried out again.

14. Method according to one of the preceding claims,
characterized in that
after the adjustment of the centering position, the toothing is discarded as scrap and the next toothing is ground with the adjusted centering position.

15. Method according to one of the preceding claims,
characterized in that
before grinding, a centering of the grinding tool (10) is carried out for a respective toothing (16) by means of a sensor (20) and/or
before grinding, a centering of the grinding tool (10) is carried out for a respective toothing (16) by whetting.
